(19) United States
(12) Patent Application Publication
(10) Pub. No.: US 2013/0331985 A1
(43) Pub. Date: Dec. 12, 2013

(54) METHOD AND APPARATUS FOR CONTROLLING AND MONITORING A VENDING MACHINE

(71) Applicant: Pascal Felique, Linkoeping (SE)

(72) Inventor: Pascal Felique, Linkoeping (SE)

(21) Appl. No.: 13/981,071

(22) PCT Filed: Jan. 28, 2011
(86) PCT No.: PCT/BE2011/000003

§ 371 Date: Aug. 28, 2013

(51) Int. Cl. G07F 9/02

(52) U.S. Cl. CPC G07F 9/02
USPC 700/244

(57) ABSTRACT

A solution comprising cost-effective methods and techniques for adding a standard vending API to a traditional vending machine, to control and monitor the vending machine during normal operation, without changing the original Vending Machine Controller (VMC) board. A key aspect of this invention is the implementation of a standard vending API by means of a proprietary data communication protocol over a network connection between a consume media playback device and an extra microcontroller in the vending machine. The present invention provides interfacing methods and a communication protocol between a consumer media playback device, a microcontroller and a Vending Machine Controller. The microcontroller implements a hardware abstraction layer to hide the underlying vending hardware towards the consumer media playback device. The consumer media playback device can run an application that uses the standard vending API to control and monitor the vending machine during normal operation, and can convert a traditional vending machine into a vending machine with a graphical user interface, multimedia advertising and info kiosk capabilities. The methods and techniques of the invention can be integrated in an MDB Slave peripheral device of a vending machine.

### BACKGROUND OF THE INVENTION

Vending machines are well known in the art. Generally they serve the purpose of selling beverages and snacks but can also be used to sell other items such as newspapers, etc. Most vending machines are operated by vending companies that offer a wide variety of services, however, companies producing beverages, also own and service a great number of vending machines. Item selection in a vending machine is performed by selecting the item using a user interface of the vending machine. The user interface of the vending machine generally contains push buttons for the user to choose the desired item. Most vending machines include a system for receiving payment for the particular article and a system for dispensing the article from the dispensing department to the merchandise removal area. When the user makes an item selection after payment has been received, the machine releases the product such that, it falls in an open compartment at the bottom, or into a cup. The product may also become available by the unlocking of a door, drawer, turning of a knob, etc. Sometimes the product is not just released but prepared.

Generally, a central processor on the Vending Machine Controller (VMC) board in the vending machine is responsible for, the control of and activities within the vending machine which include, but are not limited to: 1) communication with the payment system to keep track of the inserted amount of credit, 2) monitor button presses on the selection panel to check if the user selects an item, 3) control motor relay in the vending machine to release a product through the dispenser unit, 4) monitor drop sensor to check if the product is sold out, 5) monitor temperature sensor and control temperature of items within the vending machine by means of the cooling system. The VMC board contains a microcontroller, which is typically an Intel 8051 derived microcontroller, or a Motorola 68HC11 derived microcontroller, or other microcontroller series.

People skilled in the art are familiar with the different payment systems available within the vending industry. Vending machines that accept payment contain a payment system like a currency detector or a cashless device. Typically coin acceptors/changers, bill validators/recyclers and cashless devices are connected to the Vending Machine Controller in the vending machine by means of a serial interface, such as MDB/ICP, Executive, VCCS, BDV, Micromech, Simplex III, HII, etc. The most widely accepted serial interface within the vending industry is the MDB standard defined by NAMA (National Automatic Merchandising Association). The MDB/ICP protocol (Multi-Drop Bus/Internal Communication Protocol) is a serial bus interface for electronically controlled vending machines. It standardizes vending machines that employ electronic control so that all vending and peripheral equipment communicates identically. The MDB/ICP protocol is available from NAMA.

Most vending machines use. Sold Out leds on the front of the vending cabinet to indicate whether the product is still available or not. If the Sold Out led is on, the product is no longer available. If the Sold Out led is off, the product is still available. Most vending machines use a drop sensor to check if the product is sold out. If a purchased item does not activate the drop sensor when falling, the vending machine attempts to make another dispense of the purchased item, usually up to 3 times to ensure that a product will fall. If this still does not occur, a sold out flag is set for the particular item, and the Sold Out led which corresponds to the selected product will be set to on.

People skilled in the art are familiar with the features and advantages of telemetry within the vending industry. The fact that vending equipment tends to be strategically placed in disparate locations, presents a challenge to efficient replenishment, sales analyses, malfunction notification and comprehensive audit reporting. Telemetry offers a central management system for remotely managing (monitoring and controlling) all vending machines in operation. Aggregating machine-level data enables remote review of transactions and inventory without having to have a physical presence at the machine. Generally the central management system provides a two-way, on-demand communication with the vending machines in operation. The vending machines can be connected by means of a built in PSTN or GSM/GPRS modem enabling communication over a telephone network or a different type of connection may be used, e.g. Ethernet network interface. Telemetry systems are built on the industry standard DEX/UCS interface (Data-Exchange Uniform Code Standard). The DEX/UCS specification defines a direct connect communications interface for the interchange of data between two electronic devices. The EVA-DTS standard (European Vending Association Data Transfer Standard) is based on the DEX/UCS communications standard. The vending industry adopted this standard as a means for transferring information between vending devices. The EVA-DTS standard links two electronic devices together for transferring vending audit data (snapshot of the cumulated stored information) or configuration data (test routines and machine setup). The Vending Machine Device (VMD) in the vending machine monitors the various transactions (e.g. vends, sold outs, coins and bills accepted, etc.) and assimilates the audit data. The Data Carrier (DC) interrogates or configures the Vending Machine Device using DEX/UCS. The actual data records that are transferred follow the format of the DEX/UCS Delivery/Return Base Records. Data records unique to the vending environment are found in the, data dictionary of the EVA Data Transfer Standard. DEX data sets include sales mix, cash collection, product movement and malfunction alerts. The EVA-DTS standard is available from EVA, European Vending Association.

People skilled in the art are familiar with the features and advantages of multimedia within the vending industry. These multimedia features (picture-, movie- and sound-elements) can include a graphical user interface to increase the attractiveness of vending machines, and can include multimedia advertising and info kiosk capabilities to convert a vending machine from a beverage/candy/other item dispenser into a media channel for effective local commercials.

People skilled in the art are familiar with energy management techniques used within the vending industry to save on energy consumption and increase the life-time of components in the vending machine. Most vending machines utilize lighting behind the front panel to light up the marquee, and draw the attention to potential customers. Cold-drink vending machines utilize cooling devices to maintain the beverages at a dispensing temperature different from the ambient temperature. The cooling devices typically include a compressor to compress a refrigerant and an evaporator to evaporate the refrigerant, as is well-known to people skilled in the art. Given that most cold-drink vending machines are located in controlled environment conditions (schools, office buildings, shopping centers, etc.), it is fairly easy to predict hours of inactivity. During non-business hours or hours of inactivity, energy can be conserved by not requiring beverages to be at optimum serving temperature and turning off lighting. During times of low use, the vending machine can be completely powered down, or the vending machine's cooling system can be controlled and switched between different operation modes, allowing the advertising lighting and controller electronics to stay on while the machine is in energy savings mode.

People skilled in the art are familiar with an Application Programming Interface (API). An Application Programming Interface (API) is an abstraction layer that defines and describes a set of functions used by components of a software system. The software that provides the functions described by an API is said to be an implementation of the API.

People skilled in the art are familiar with a Hardware Abstraction Layer (HAL). A Hardware Abstraction Layer (HAL) is an abstraction layer, implemented in software, between the physical hardware of an electronic system, and the software that runs on that electronic system. Its function is to hide differences in hardware from the software applications which are running on the hardware, so that most of the software code does not need to be changed to run on systems with different hardware.

Although efforts have been made to make vending machines more attractive to the public such as adding multimedia capabilities for simplifying the operation of the machine, increasing the user interactivity, and playing back audio-visual content on a screen, these have never been implemented on a wide scale basis in the majority of vending machines for dispensing beverages, candies or other items because of the high cost of integrating multimedia capabilities into a vending machine.

Vending machines in accordance with prior art that have no graphical user interface and multimedia capabilities are hereinafter referred to as traditional vending machines.

An objective of the present invention is to add a standard vending API to a traditional vending machine, to control and monitor the vending machine during normal operation, without changing the original VMC board.

The standard vending API software library can become an industry standard for writing new interactive vending portals for legacy vending machines. Interactive vending applications implemented on top of the standard vending API will run out-of-the-box on different vending machine brands and types. The developer can focus on the interactivity of the vending application, rather than on the specific details of the vending machine on which it is implemented. This will allow the vending operator, to run the same interactive vending portal on different vending machine brands and types that are equipped with the retro-fit kit.

The interactive vending portal will convert a traditional vending machine into a vending machine with a graphical user interface, multimedia advertising and info kiosk capabilities.

### SUMMARY OF THE INVENTION

The present invention relates to cost-effective methods and techniques for adding a standard vending API to a traditional vending machine, to control and monitor the vending machine during normal operation, without changing the original VMC board.

The standard vending API to control and monitor the vending machine during normal operation is implemented by means of a proprietary data communication protocol over a network connection between a consumer media playback device and an extra microcontroller in the vending machine. The microcontroller implements a hardware abstraction layer to hide the underlying vending hardware towards the consumer media playback device.

Any consumer media playback device with a network interface, such as a Blu-ray player, Smartphone, Tablet, etc. can implement the standard vending API to control and monitor the vending machine during normal operation.

The consumer media playback device can run an application that uses the standard vending API to control and monitor the vending machine during normal operation, and can convert a traditional vending machine into a vending machine with a graphical user interface, multimedia advertising and info kiosk capabilities.

A specific aspect of the technology described in this invention, is the changed logic of a traditional vending machine to delay dispense of the selected item until a video clip has been played. Embodiments of this invention provide methods and techniques to implement the control logic of a delayed vending scenario on a stand-alone consumer media playback device.

The embodiments of the present invention provide methods and techniques for integrating a stand-alone consumer media playback device with a network interface in a vending machine.

The methods and techniques of the invention can be integrated in an MDB Slave peripheral device of a vending machine compatible with the MDB standard, such that said peripheral device provides a standard vending API for controlling and monitoring said vending machine.

### BRIEF DESCRIPTION OF THE DRAWINGS

The objects and features of the present invention will become more apparent and the invention will be best understood from the following detailed description of the preferred embodiments, when read with reference to the accompanying drawings wherein:

FIG. 1 is a Block diagram of a traditional vending machine

FIG. 2 is a Block diagram of a converted vending machine with an extra microcontroller

FIG. 3 is an alternative Block diagram of a converted vending machine with an extra microcontroller, whereby the microcontroller communicates with the DEX connector

FIG. 4 is a Block diagram of an MDB Slave peripheral which adds a vending API to the vending machine

FIG. 5 is an alternative Block diagram of an MDB Slave peripheral which adds a vending API to the vending machine, whereby the MDB Slave peripheral communicates with the DEX connector

FIG. 6 shows the different abstraction layers in the presented embodiments

FIG. 7 shows the integration of a future Vending Machine Controller that has a network interface

FIGS. 8-12 show alternative embodiments of embodiments 1-5 in the present invention whereby a network gateway is placed in between the network interface of the consumer media playback device and the network module of the microcontroller

### DETAILED DESCRIPTION

The present invention relates to cost-effective methods and techniques for adding a standard vending API to a traditional vending machine, to control and monitor the vending machine during normal operation, without changing the original VMC board.

The standard vending API to control and monitor the vending machine during normal operation is implemented by means of a proprietary data communication protocol over a network connection between a consumer media playback device and an extra microcontroller in the vending machine. The microcontroller implements a hardware abstraction layer to hide the underlying vending hardware towards the consumer media playback device.

Any consumer media playback device with a network interface, such as a Blu-ray player, Smartphone, Tablet, etc. can implement the standard vending API to control and monitor the vending machine during normal operation.

The consumer media playback device can run an application that uses the standard vending API to control and monitor the vending machine during normal operation, and can convert a traditional vending machine into a vending machine with a graphical user interface, multimedia advertising and info kiosk capabilities.

The methods and techniques in the present invention do not require the same level of complexity as the methods and techniques described in the publication with reference PCT/BE2007/000074, “Method and apparatus for controlling a vending machine”, which was filed on Jul. 6, 2007 by applicants Pascal Felique and Christian Felique.

The embodiments of the present invention provide methods and techniques for integrating a stand-alone consumer media playback device with a network interface in a vending machine. The network interface on the consumer media playback device simplifies the integration in a vending machine.

PCT/BE2007/000074 describes methods and techniques to add a graphical user interface, multimedia advertising and info kiosk capabilities to a traditional vending machine by integrating a stand-alone consumer DVD player in the vending machine. A stand-alone consumer DVD player has limitations on the available interfaces as a consumer DVD player is primarily designed for the playback of movies and music. The described methods and techniques in PCT/BE2007/000074 make use of the available infrared input and the available audio and video outputs on the DVD player.

PCT/BE2007/000074 describes an embodiment without an extra microcontroller. The user can navigate and make an item selection in a graphical user interface which is implemented as a Selections DVD Menu. The user can navigate in the graphical user interface by means of the selection panel that is connected to the remote control which sends an infrared signal to the infrared input of the DVD player. When the user has made an item selection in the Selections DVD Menu, the DVD player plays a special Audio or Video Control Movie which is decoded on the audio or video outputs of the DVD player through associated electronics, to translate the item selection in the Selections DVD Menu into a proper electronic signal wired to the keyboard decoder of the Vending Machine Controller. The Vending Machine Controller will dispense the item if the item is available and enough credit was inserted. Before the special Audio or Video Control Movie is played, the DVD player can play a video clip, to implement the control logic of a delayed vending scenario: the selected item is dispensed after a video clip has been played.

PCT/BE2007/000074 describes an embodiment with an extra microcontroller which can check the item availability and the credit status in the vending machine. The infrared input on the DVD player is not only used by the user to navigate within the Selections DVD Menu. The infrared input on the DVD player is also used by the microcontroller to signal a vend decision to the DVD player depending on the item availability and the credit status in the vending machine. The infrared input on the DVD player is also used by the microcontroller to signal a credit event to the DVD player when a coin or bill was inserted in the payment system available in the vending machine. The user can navigate and make an item selection in a graphical user interface which is implemented as a Selections DVD Menu. The microcontroller can signal a vend decision to the DVD player in a special Decision DVD Menu with invisible menu items. The microcontroller can signal a credit event to the DVD player in the Selections DVD Menu and a special Coin Insertion DVD Menu with invisible menu items. The user can navigate in the graphical user interface by means of the selection panel that is connected to an input port of the microcontroller, which sends an infrared signal through the infrared sender to the infrared input of the DVD player. The microcontroller monitors the data traffic between the Vending Machine Controller and the payment system on the background, and will signal the credit event to the DVD player in the Selections DVD Menu and the Coin Insertion DVD Menu, by sending an infrared signal through the infrared sender to the infrared input of the DVD player. The DVD player can internally increment the credit status in a GPRM register and can jump to the proper Selections DVD Menu which displays the current credit value in the background. When the user has made an item selection in the Selections DVD Menu, the DVD player plays a special Audio or Video Control Movie which is decoded on the audio or video outputs of the DVD player through associated electronics, to translate the item selection in the Selections DVD Menu into a proper electronic signal wired to an input port of the microcontroller. After the microcontroller received the selected item by decoding the special Audio or Video Control Movie, the microcontroller will check the item availability and the credit status in the vending machine, and will signal the vend decision to the DVD player in the Decision DVD Menu by sending an infrared signal through the infrared sender to the infrared input of the DVD player. The DVD player can play a “Sold Out” video information message when the selected item is not available anymore. The DVD player can play a “Low Funds” video information message when the user did not insert enough credit. The DVD player can play a video clip when the selected item is available and the user did insert enough credit. After the video clip is played, the DVD player plays again a special Audio or Video Control Movie to signal the end of the video clip to the microcontroller which will generate a proper electronic signal wired to the keyboard decoder of the Vending Machine Controller. The Vending Machine Controller will dispense the item if the item is available and enough credit was inserted.

The present invention relates to cost-effective methods and techniques for adding a standard vending API to a traditional vending machine, to control and monitor the vending machine during normal operation, without changing the original VMC board.

The standard vending API to control and monitor the vending machine during normal operation is implemented by means of a proprietary data communication protocol over a network connection between a consumer media playback device and an extra microcontroller in the vending machine. The microcontroller implements a hardware abstraction layer to hide the underlying vending hardware towards the consumer media playback device.

Any consumer media playback device with a network interface, such as a Blu-ray player, Smartphone, Tablet, etc. can implement the standard vending API to control and monitor the vending machine during normal operation.

In order to simplify the understanding of the invention, rather than describing the invention in abstract terms, some of the descriptions herein are in terms of a specific consumer media playback device with a network interface, namely a Blu-ray player. However, it should be understood that the invention is not limited for use by any specific consumer media playback device.

Blu-ray (BD) refers to the next-generation optical disc format which was developed by the Blu-ray Disc Association (BDA). The format was developed to enable recording, rewriting and playback of high-definition video (HD), as well as storing large amounts of data. The Blu-ray disc format is meant to replace the DVD disc format in the long run, with storage capacities that are currently as high as 50 GB, but may soon reach 100 GB or higher. The name Blu-ray is derived from the blue-violet laser it uses to read and write to the disc.

Each Blu-ray player contains a Java Virtual Machine (JVM). A Java Virtual Machine (JVM) is a platform independent environment with a virtual machine model for the execution of Java applications. Java provides interactive capabilities to Blu-ray and allows content providers to provide more interactivity in the movie titles to the consumers. Conceptually, the JVM is a real computer, which is just not implemented in hardware. The machine has storage capacity, its own memory model, an arithmetic unit with a well defined behavior, and an internal machine language.

BD-J refers to the application programming environment that is supported by Blu-ray systems, and is based on the Personal Basis Profile (PBP) of the Java ME standard. Having a full programming environment available on every Blu-ray player provides developers with an extremely flexible platform for creating innovative new content types. The author has freedom in designing the graphical user interface, which can display dynamically generated graphics and supports the display of pictures in standard file formats like JPEG, PNG, etc. The BD-J application's GUI can be operated with a remote control with a required set of keys and an optional pointing device. The menus on Blu-Ray discs are more interactive than DVDs and can be displayed simultaneously with any video clip on the background. The video can be scaled dynamically so that it can be played in a small size in the corner of a menu and resume full screen when a selection is made.

BD-J allows bonus content on BD titles to be far more sophisticated than on DVD through: network access, Picture-In-Picture support and access to local storage. These additional features (other than internet access) are referred to as “Bonus View”, and the addition of internet access is called “BD Live”. The Blu-ray player with support for “BD Live” has a network interface connector. The Blu-ray player contains a small amount of non-volatile system storage (flash memory). This system storage can be used to store bookmarks, favorites from a disc, training course results, etc. The Blu-ray player may also be equipped with Local. Storage (e.g. a hard disk, to allow large amounts of data like audio/video to be stored).

BD-J applications can use the java.net package to connect to servers on the Internet. The physical connection might differ between implementations e.g. Ethernet, telephone line, etc. At the network level, TCP/IP is supported and the HTTP protocol may be used. The Java package for secure connections is included (JSSE) as part of the BD-J platform. Before a BD-J application can use the network connection, it must be authenticated and have suitable permission to use the network. The Blu-ray player may connect to the disc publisher's web site to unlock certain content on the disc or dynamically display certain info on the screen. The disc's program may be extended with JPEG pictures or audio fragments downloaded from the Internet, or it can even stream full new audio/visual content to Local Storage.

The present invention relates to cost-effective methods and techniques for adding a standard vending API to a traditional vending machine, to control and monitor the vending machine during normal operation, without changing the original VMC board.

The present invention provides interfacing methods and a communication protocol between a consumer media playback device, a microcontroller and a Vending Machine Controller.

The embodiments of the present invention provide methods and techniques for integrating a stand-alone consumer media playback device with a network interface in a vending machine.

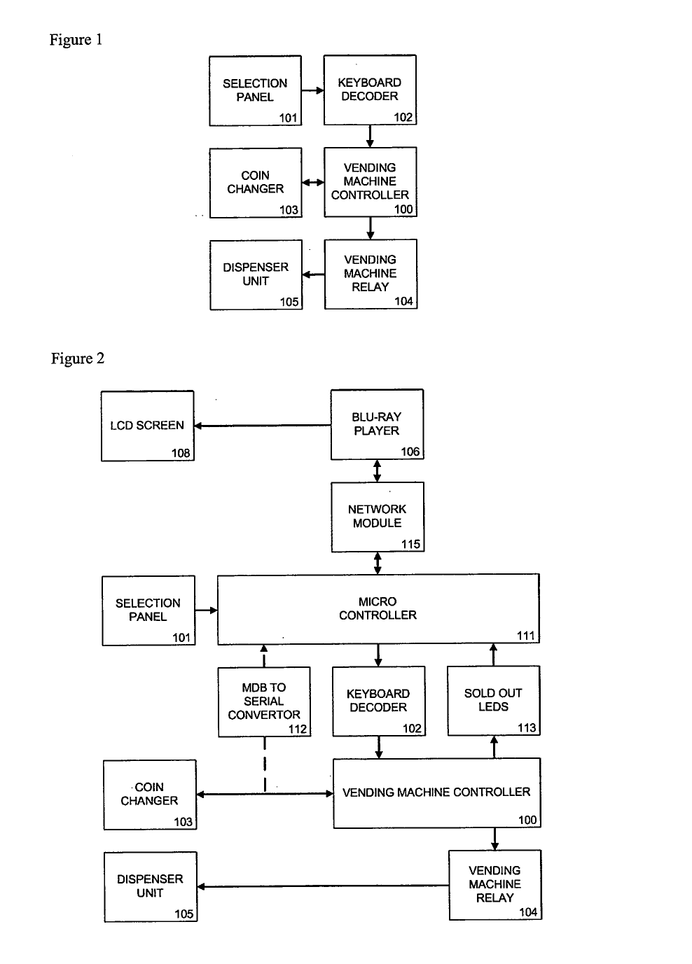

FIG. 1 shows a block diagram of a traditional vending machine. The VEND scenario on a traditional vending machine consists of at least the following steps: 1) the customer inserts coins in the coin changer 103, 2) for each coin insertion, the Vending Machine Controller 100 increases the internal credit status with the inserted coin value, 3) the customer pushes a button on the selection panel 101 to select the desired beverage/item, 4) the Vending Machine Controller 100 checks if the item is still available and if the customer inserted enough credit, 5) the Vending Machine Controller 100 activates a motor relay 104, 6) the selected beverage/item is dispensed through a dispenser unit 105 when the vend was successful.

In a traditional vending machine the selection panel 101 is directly connected to the keyboard decoder 102 of the Vending Machine Controller 100. The expression “keyboard decoder of the Vending Machine Controller” can be used interchangeably with the expressions “keyboard decoder integrated in the Vending Machine Controller”, “integrated keyboard decoder in the Vending Machine Controller”, “keyboard decoder in the Vending Machine Controller”, “keyboard decoder connected to the Vending Machine Controller”, “selection panel connected to the internal communication bus in the vending machine e.g. MDB Universal Satellite Device peripheral used as MDB Slave peripheral device”. One skilled in the art will recognize that different types of configurations between selection panel, keyboard decoder and Vending Machine Controller exist.

In one embodiment of this invention (embodiment 1), a standard vending API is added to a traditional vending machine, to control and monitor the vending machine during normal operation, by integrating an extra microcontroller 111 in the vending machine which monitors the vending peripheral bus and the sold leds 113 in the vending machine, and controls the keyboard decoder 102 in the vending machine. The standard vending API to control and monitor the vending machine during normal operation is implemented by means of a proprietary data communication protocol over a network connection between a consumer media playback device 106 and the extra microcontroller 111 in the vending machine. The consumer media playback device 106 runs an application that uses the standard vending API to control and monitor the vending machine during normal operation, and adds a graphical user interface, multimedia advertising and info kiosk capabilities to the vending machine.

In order to simplify the understanding of the invention, rather than describing the invention in abstract terms, some of the descriptions herein are in terms of a specific consumer media playback device with a network interface, namely a Blu-ray player 106. However, it should be understood that the invention is not limited for use by any specific consumer media playback device.

FIG. 2 shows a Block diagram of a converted vending machine with an extra microcontroller 111: In this embodiment, the selection panel 101 on the vending machine is disconnected from the keyboard decoder 102 of the Vending Machine Controller 100. The original selection panel 101 on the vending machine can be re-used and connected to an input port of the microcontroller 111 using associated electronics. Alternatively a completely new selection panel with navigation buttons can be connected to an input port of the microcontroller 111 using associated electronics.

When the vending machine is newly built in the factory, the selection panel 101 with navigation buttons is mounted directly to an input port of the microcontroller 111 using associated electronics, without having to disconnect the selection panel 101 from the keyboard decoder 102 first as that connection was never made before.

The keyboard decoder 102 of the Vending Machine Controller 100 is connected to an output port of the microcontroller 111 using associated electronics.

The Sold Out panel with Sold Out leds 113 on the vending machine is connected to an input port of the microcontroller 111 using associated electronics.

The conversion circuit 112 is connected to the serial port on the microcontroller 111 and is used to convert the MDB protocol to standard serial data, so that the microcontroller 111 can monitor the MDB communication between the Coin Changer 103 and the Vending Machine Controller 100 on the background to monitor coin or bill insertions on the vending machine. Serial data protocols can be easily monitored by a serial port on the microcontroller 111. People skilled in the art will appreciate that other protocols besides the MDB protocol can be handled as well, as long as the microcontroller 111 can monitor and interpret the data communication between the VMC 100 and the coin changer 103 and/or bill validator or any other payment devices.

The network interface on the Blu-ray player 106 is connected to the network module 115 of the microcontroller 111. The expression “network module of the microcontroller” can be used interchangeably with the expressions “network module integrated in the microcontroller”, “integrated network module in the microcontroller”, “network module in the microcontroller”, “network module connected to the microcontroller”. Some microcontrollers on the market have an integrated network module by design. The connection between the network interface on the Blu-ray player 106 and the network module 115 of the microcontroller 111 is further referred to as “network connection”.

The video output of the Blu-ray player 106 will be connected to an LCD display 108. Different types of video connections between the Blu-ray player 106 and the LCD display 108 are possible, e.g. composite video, SCART, RGB, component video, HDMI and other future video standards. Next to LCD displays, it is evident that other display types could be used as well: CRT screens, plasma screens, etc. The audio outputs will be connected to integrated LCD speakers or external speakers.

In a preferred embodiment of the present invention, a number of modifications are made to the outer cabinet. The description of modifications set forth below is not intended to represent the only form in which the exemplary embodiments may be constructed or utilized. One skilled in the art will recognize that different modifications can be used to accomplish the techniques of the present invention that achieve the same functionality.

In a preferred embodiment of the present invention, at least the following modifications are made to the outer cabinet:

If a new selection panel 101 is mounted on the vending machine, it can be mounted in addition to the original selection panel 101 on the vending machine, or it can replace the original selection panel 101 which is removed from the vending machine. The new selection panel 101 with navigation buttons is preferably mounted on the front of the vending cabinet, but other mount configurations are possible.

The LCD display 108 and audio speakers will be integrated into the front cover of the vending cabinet. Most vending cabinets come with replaceable front covers that can be easily exchanged. The existing front cover will be replaced with a custom front cover of similar outer dimensions. An opening is shaped in the front cover which can house the new selection panel 101, the LCD display 108 and speakers. To protect the LCD display 108 and speakers against vandalism, a protective shield to cover the LCD display 108 and a sound permeable mesh to cover the speakers can be used. Most front panels offer enough space to integrate LCD displays 108 (and speakers) with a small form factor. The current space is mostly used for light tubes to illuminate the marquee. In some cases it is desirable not to install the video screen and other components in the existing vending machine, but it is instead desirable to install the components adjacent or on top of the existing machine.

The Blu-ray disc in the Blu-ray player 106 contains a Java application that implements a graphical user interface, monitors incoming data on the network interface of the Blue-ray player 106, and uses a proprietary data communication protocol to communicate with the microcontroller 111 over the network connection. The data communication protocol can be used to: 1) signal button presses on the selection panel 101, 2) request item availability from the vending machine, 3) signal credit activity on the vending machine, and 4) pass on the item selection to the vending machine. The Blu-ray disc can also contain video clips.

The Java application can send data to the microcontroller 111 over the network connection. The microcontroller 111 can send data to the Java application over the network connection. The Java application can receive data from the microcontroller 111 over the network connection. The microcontroller 111 can receive data from the Java application over the network connection.

Navigation in the graphical user interface to select an item on the vending machine: The user can use the selection panel 101 on, the vending machine to navigate and make an item selection in a graphical user interface which is implemented as a Selections Blu-ray Menu: The microcontroller 111 translates a button press on the selection panel 101, to a network data segment that contains the “key event—navigation code”, which is sent over the network connection to, the Java application. The Java application monitors the incoming data on the network interface of the Blue-ray player 106 and when it receives a “key event” it performs the corresponding navigation action for the “navigation code” within the graphical user interface.

Monitor credit activity on the vending machine: The microcontroller 111 monitors the MDB communication between the Coin Changer 103 and the Vending Machine Controller 100 on the background to monitor coin or bill insertions on the vending machine: The microcontroller 111 translates a coin insertion in the payment system, to a network data segment that contains the “credit event—coin type”, which is sent over the network connection to the Java application. The Java application monitors the incoming data on the network interface of the Blue-ray player 106 and when it receives a “credit event” it increases the internal credit status stored in a memory location with the corresponding “coin type” value, and updates the current credit status within the graphical user interface.

Request item availability for an item in the vending machine: The Java application can request information about item availability by sending a network data segment that contains the “item availability request—selected item”, over the network connection to the microcontroller 111: The microcontroller 111 monitors the incoming data on the network module 115 and when it receives an “item availability request” it reads out the digital logical value of the corresponding Sold Out led 113 on the Sold Out panel, and sends a network data segment with the “item availability status—selected item” over the network connection to the Java application. The Java application monitors the incoming data on the network interface of the Blue-ray player 106 and when it receives an “item availability status” it stores the item availability status for the “selected item” in a memory location. The Java application can check the item availability for all available item selections up front, and can disable the items which are not available anymore in the Selections Blu-ray Menu.

Pass on an item selection to the vending machine: The Java application can pass on an item selection to the Vending Machine Controller 100 by sending a network data segment that contains the “item selection request—selected item”, over the network connection to the microcontroller 111: The microcontroller 111 monitors the incoming data on the network module 115 and when it receives an “item selection request” it translates the “selected item” into a proper electronic signal wired to the keyboard decoder 102 of the Vending Machine Controller 100. The Vending Machine Controller 100 will dispense the item if the item is available and enough credit was inserted.

The VEND scenario on a converted vending machine with extra microcontroller 111 consists of at least the following steps:

1) The user can use the selection panel 101 on the vending machine to navigate and make an item selection in a graphical user interface which is implemented as a Selections Blu-ray Menu.

2) The user can insert coins in the payment system 103 on the vending machine, and the Java application will update the current credit status in the Selections Blu-ray Menu when it detects a coin insertion in the payment system 103.

3) When the user has made an item selection in the Selections Blu-ray Menu, the Java application on the Blu-ray player 106 stores the selected item in a memory location.

4) The Java application checks the item availability, and plays a “Sold Out” video information message when the selected item is not available anymore, and returns back to the Selections Blu-ray Menu, so that the user can make a new item selection within the graphical user interface.

5) The Java application checks the current credit status, and plays a “Low Funds” video information message when the item price for the selected item is higher than the current credit status, and returns back to the Selections Blu-ray Menu, so that the user can make a new item selection within the graphical user interface.

6) When the selected item is available, and the current credit status is higher than or equal to the selected item price, the Java application plays a video clip with an advertisement or a public information message, and passes on the item selection to the vending machine. The vending machine will dispense the item if the item is available and enough credit was inserted. The Java application returns back to the Selections Blu-ray Menu, and updates the current credit status, so that the user can make a new item selection within the graphical user interface.

The prices for the items in the vending machine can be stored on the Blu-ray disc during the authoring phase. Alternatively the prices for the items in the vending machine can be stored in the local flash memory of the Blu-ray player 106. The vending operator can store the prices in the flash memory of the Blu-ray player 106 by means of a special Java application stored on a vending operator service Blu-ray disc. The vending operator inserts the service Blu-ray disc in the Blu-ray player 106 during installation or maintenance of the vending machine. The Java application on the service Blu-ray disc implements a graphical user interface which provides options to configure the pricing for each item in the vending machine individually, and can write the values to the flash memory of the Blu-ray player 106. After the vending machine has been installed or serviced, the service Blu-ray disc in the Blu-ray player 106 is replaced by the Blu-ray disc which runs during normal operation of the vending machine.

In another embodiment of this invention (embodiment 2), a standard vending API is added to a traditional vending machine, to control and monitor the vending machine during normal operation, by integrating an extra microcontroller 111 in the vending machine which monitors the vending peripheral bus, reads and writes data to the DEX connector in the vending machine, and controls the keyboard decoder 102 in the vending machine. The standard vending API to control and monitor the vending machine during normal operation is implemented by means of a proprietary data communication protocol over a network connection between a consumer media playback device 106 and the extra microcontroller 111 in the vending machine. The consumer media playback device 106 runs an application that uses the standard vending API to control and monitor the vending machine during normal operation, and adds a graphical user interface, multimedia advertising and info kiosk capabilities to the vending machine.

In order to simplify the understanding of the invention, rather than describing the invention in abstract terms, some of the descriptions herein are in terms of a specific consumer media playback device with a network interface, namely a Blu-ray player 106. However, it should be understood that the invention is not limited for use by any specific consumer media playback device.

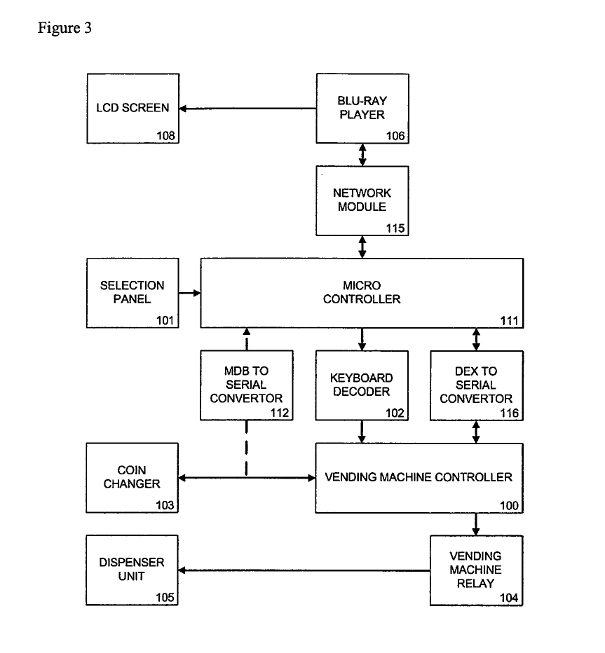

FIG. 3 shows an alternative Block diagram of a converted vending machine with an extra microcontroller 111: In this embodiment, the microcontroller 111 is not connected to the Sold Out leds 113 of the Sold Out panel on the vending machine. The conversion circuit 116 is connected to the serial port on the microcontroller 111 and is used to convert the DEX protocol to standard serial data, so that the microcontroller 111 can write to and read from the DEX connector on the Vending Machine Controller 100. The expression “DEX connector on the Vending Machine Controller” can be used interchangeably with the expressions “DEX connector integrated in the Vending Machine Controller”, “integrated DEX connector in the Vending Machine Controller”, “DEX connector in the Vending Machine Controller”, “DEX connector connected to the Vending Machine Controller”.

People skilled in the art will recognize that the microcontroller 111 can read out vending audit data (snapshot of the cumulated stored information) from the Vending Machine Controller 100 through the DEX connector. People skilled in the art will recognize that the microcontroller 111 can write configuration data (test routines and machine setup) to the Vending Machine Controller 100 through the DEX connector.

The microcontroller 111 can request the item availability for the selected item through the DEX connector. The microcontroller 111 can request the item price for the selected item through the DEX connector. The microcontroller 111 can update the item price for the selected item through the DEX connector. People skilled in the art will recognize that the microcontroller 111 can request other vending audit data through the DEX connector, such as: item stock, total amount of cash, malfunction alerts, etc.

The Blu-ray disc in the Blu-ray player 106 contains a Java application that implements a graphical user interface, monitors incoming data on the network interface of the Blue-ray player 106, and uses a proprietary data communication protocol to communicate with the microcontroller 111 over the network connection. The data communication protocol can be used to: 1) signal button presses on the selection panel 101, 2) request item availability from the vending machine, 3) signal credit activity on the vending machine, 4) pass on the item selection to the vending machine, 5) request item pricing from the vending machine, 6) update item pricing on the vending machine, 7) request item stock from the vending machine, 8) request credit inventory from the vending machine, 9) request malfunction alerts from the vending machine, 10) perform a test routine on the vending machine, 11) update the software on the vending machine, etc. The Blu-ray disc can also contain video clips.

The Java application can send data to the microcontroller 111 over the network connection. The microcontroller 111 can send data to the Java application over the network connection. The Java application can receive data from the microcontroller 111 over the network connection. The microcontroller 111 can receive data from the Java application over the network connection.

Request vending audit data from the vending machine: The Java application can request specific vending audit data from the vending machine by sending a network data segment that contains the “vending audit data request—DEX parameter”, over the network connection to the microcontroller 111: The microcontroller 111 monitors the incoming data on the network module 115 and when it receives a “vending audit data request” it reads out the value of the corresponding “DEX parameter” through the DEX connector on the Vending Machine Controller 100, and sends a network data segment with the “vending audit data Information—DEX parameter” over the network connection to the Java application. The Java application monitors the incoming data on the network interface of the Blue-ray player 106 and when it receives the “vending audit data information” it stores the value for the “DEX parameter” in a memory location.

Write configuration data to the vending machine: The Java application can write configuration data to the vending machine by sending a network data segment that contains the “configuration data request—DEX parameter—value”, over the network connection to the microcontroller 111: The microcontroller 111 monitors the incoming data on the network module 115 and when it receives a “configuration data request” it writes the “value” to the corresponding “DEX parameter” through the DEX connector on the Vending Machine Controller 100, and sends a network data segment with the “configuration data request—acknowledge” over the network connection to the Java application. The Java application monitors the incoming data on the network interface of the Blue-ray player 106 and waits for an acknowledgement of the write operation.

People skilled in the art will recognize that the method and technique to request item availability for an item in the vending machine is based on the method and technique to request vending audit data from the vending machine. People skilled in the art will recognize that the method and technique to update item pricing on the vending machine is based on the method and technique to write configuration data to the vending machine. People skilled in the art will recognize that the method and technique to perform a test routine or update the software on the vending machine is based on the method and technique to write configuration data to the vending machine.

People skilled in the art will recognize that the methods and techniques to 1) navigate in the graphical user interface to select an item, 2) monitor credit activity on the vending machine, and 3) pass on an item selection to the vending machine, use the same methods and techniques as in the first embodiment of this invention.

People skilled in the art will recognize that some Vending Machine Controllers 100 support the feature to dispense an item from the vending machine by sending a vend request to the DEX connector. When this feature is supported by the. Vending Machine Controller 100 in this embodiment, the microcontroller 111 does no longer need to pass the item selection to the vending machine by translating the “selected item” into a proper electronic signal wired to the keyboard decoder 102 of the Vending Machine Controller 100, but can simply send a vend request for the selected item to the DEX connector.

People skilled in the art will recognize that in this embodiment there is no need to store the pricing on the Blu-ray disc, or in the flash memory of the Blu-ray player 106, as the Java application can request the pricing information by sending a request to the microcontroller 111 over the network connection, which will request the pricing information through the DEX connector and send it back to the Java application over the network connection.

The vending operator can update the prices in the vending machine by means of a special Java application stored on a vending operator service Blu-ray disc. The vending operator inserts the service Blu-ray disc in the Blu-ray player 106 during installation or maintenance of the vending machine. The Java application on the service Blu-ray disc implements a graphical user interface which provides options to configure the pricing for each item in the vending machine individually, and can write the values to the microcontroller 111 over the network connection, which writes them to the vending machine through the DEX connector. After the vending machine has been installed or serviced, the service Blu-ray disc in the Blu-ray player 106 is replaced by the normal operation Blu-ray disc.

People skilled in the art will recognize that the Java application stored on the vending operator service Blu-ray disc can implement a graphical user interface that provides options to read out additional vending audit data from the vending machine or to write additional configuration data to the vending machine. The vending operator can retrieve sales information and statistics from the vending machine which are displayed by the Java application in the graphical user interface. The vending operator can retrieve malfunction alerts from the vending machine, which are displayed by the Java application in the graphical user interface.

The Java application which is designed to perform service operations on the vending machine during the installation or maintenance of the vending machine, does not need to reside on a separate vending operator service Blu-ray disc, but can be added to the Blu-ray disc which runs during normal operation of the vending machine. The service functionality can be made available through a hidden menu in the graphical user interface of the main Java application, which can be activated through a special key combination sequence and a pin code that the vending operator can enter by means of the selection panel 101 on the vending machine. The service functionality in the graphical user interface provides significant advantages for servicing the traditional vending machine: 1) the vending operator does not have to open the vending machine to update the item pricing or to consult the item stock, 2) the vending operator does not have to carry a separate hand-held terminal on his vending route for servicing the vending machine, 3) the servicing of the vending machine is more user friendly by means of the graphical user interface. People skilled in the art will recognize that the Vending Machine Controller 100 can require that the door is open before it accepts any service operations by means of a door sensor in the vending machine. People skilled in the art will recognize that the microcontroller 111 can connect to the door sensor and simulate an open door to overcome this restriction.

In a further embodiment of this invention (embodiment 3), a standard vending API is added to a traditional vending machine, to control and monitor the vending machine during normal operation, by integrating an extra microcontroller 111 in the vending machine which communicates with the vending machine over the vending peripheral bus, and acts as an MDB Slave peripheral which has its own unique peripheral address and proprietary vending command set. The standard vending API to control and monitor the vending machine during normal operation is implemented by means of a proprietary data communication protocol over a network connection between a consumer media playback device 106 and the extra microcontroller 111 in the vending machine. The consumer media playback device 106 runs an application that uses the standard vending API to control and monitor the vending machine during normal operation, and adds a graphical user interface, multimedia advertising and info kiosk capabilities to the vending machine.

In order to simplify the understanding of the invention, rather than describing the invention in abstract terms, some of the descriptions herein are in terms of a specific consumer media playback device with a network interface, namely a Blu-ray player 106. However, it should be understood that the invention is not limited for use by any specific consumer media playback device.

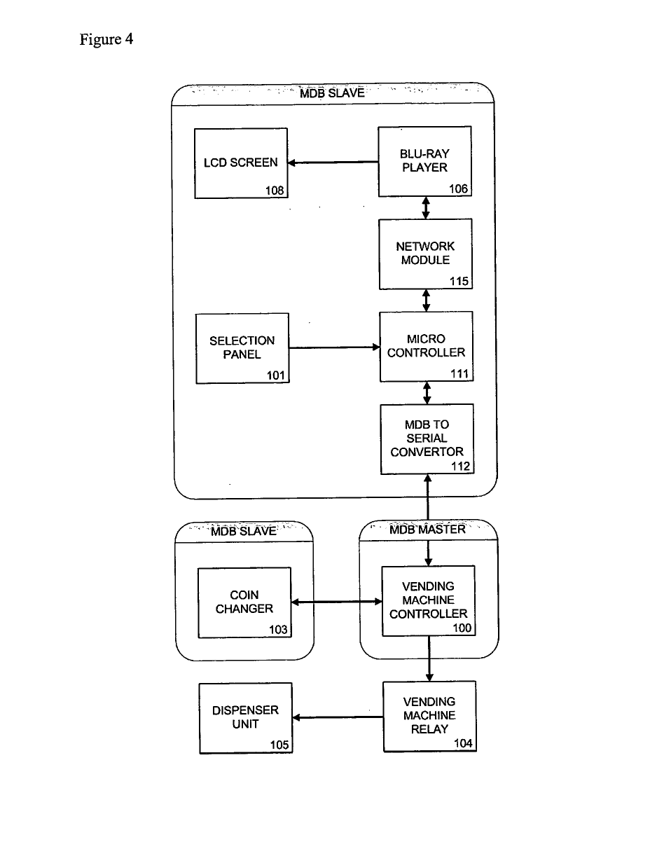

FIG. 4 shows a Block diagram of an MDB Slave peripheral which adds a vending API to the vending machine: In this embodiment, the microcontroller 111 communicates with the vending machine over the vending peripheral bus, and acts as an MDB Slave peripheral which has its own unique peripheral address and proprietary vending command set.

The MDB interface provides a Master-Slave arrangement where all peripherals are Slaves to a Master controller. It is used to standardize vending machines that employ electronic control so that all vending and peripheral equipment communicates identically. In general, there is one Master with capability of communicating with up to 32 peripherals. The Master is defined as the Vending Machine Controller. Each peripheral is assigned a unique address and command set. The master will “poll” the bus for peripheral activity. That is, each peripheral is asked for activity, and responds with either an, acknowledgement, negative acknowledgment, or specific data dependent on its current activity. If a peripheral does not respond within a predefined time it is assumed that it is not present on the bus.

The MDB Slave peripheral implemented by the microcontroller 111 has its own unique peripheral address and proprietary vending command set. When designing and field testing potential new MDB devices, Experimental Peripheral Addresses can be used. These addresses are temporary and once the new device is approved by NAMA and the EVA, the device will be assigned a different permanent peripheral address.

The MDB Slave peripheral can operate in 3 modes:

IDLE mode: When the microcontroller 111 did not receive any vending request from the Java application on the Blu-ray player 106 through the network connection, or did not receive an event from the Vending Machine Controller 100 through the MDB bus, it operates in IDLE mode: the MDB Slave is in IDLE mode.

REQUEST mode: When the microcontroller 111 received a vending request from the Java application on the Blue-ray player 106 through the network connection it operates in REQUEST mode: the MDB Slave is in REQUEST mode.

EVENT mode: When the microcontroller 111 received an event from the Vending Machine Controller 100 through the MDB bus it operates in EVENT mode: the MDB Slave is in EVENT mode.

The MDB Master can poll the MDB Slave for activity. When the MDB Slave is in IDLE mode, it will answer with “IDLE”: the MDB Master will poll the MDB Slave again, until the MDB Slave requests vending information from the vending machine. When the MDB Slave is in REQUEST mode, it will answer the “poll” from the MDB Master with a specific vending request: the MDB Master will answer the request with the requested vending information.

The MDB Slave can only accept a new vending request from the Java application on the Blu-ray player 106 through the network connection when it operates in IDLE mode. When the MDB Slave is still in REQUEST mode, the Java application has to wait until the previous vending request is processed, and the MDB Slave is back in IDLE mode. When the MDB Slave is still in EVENT mode, the Java application has to wait until the event is processed, and the MDB Slave is back in IDLE mode.

The MDB Master can send vending events on the vending machine to the MDB Slave when the MDB Slave is in IDLE mode. The MDB Slave can only accept an event from the Vending Machine Controller 100 through the MDB bus when it operates in IDLE mode. When the MDB Slave is still in REQUEST mode, and there is an event on the vending machine, the Vending Machine Controller 100 has to wait until the previous vending request is processed, and the MDB Slave is back in IDLE mode. When the MDB Slave is still in EVENT mode, the Vending Machine Controller 100 has to wait until the event is processed, and the MDB Slave is back in IDLE mode.

The proprietary MDB vending command set provides the microcontroller 111 (acting as MDB Slave peripheral towards the vending machine) means to request vending information from the Vending Machine Controller 100 (MDB Master) through the MDB bus. The vending information which the microcontroller 111 can retrieve from the Vending Machine Controller 100 includes but is not limited to: 1) item availability, 2) item pricing, 3) item stock, 4) credit inventory, etc.

The proprietary MDB vending command set provides the Vending Machine Controller 100 (MDB Master) means to signal vending events on the vending machine to the microcontroller 111 (acting as MDB Slave peripheral towards the vending machine) through the MDB bus. The vending events which the Vending Machine Controller 100 can signal to the microcontroller 111 include but are not limited to: 1) coin insertions, 2) bill insertions, 3) cashless payment, 4) malfunction alert, etc.

The proprietary MDB vending command set provides the microcontroller 111 (acting as MDB Slave peripheral towards the vending machine) means to write configuration data or send an action to the Vending Machine Controller 100 (MDB Master) through the MDB bus. The configuration data or actions which the microcontroller 111 can write/send to the Vending Machine Controller 100 include but are not limited to: 1) update item pricing, 2) perform vend, 3) increase current credit value in vending machine, etc.

In this embodiment the vending software on the Vending Machine Controller 100 in the traditional vending machine is changed to communicate with the new MDB Slave peripheral: the main vending software loop will now also communicate with the new MDB Slave peripheral in addition to the MDB payment system. When the vending machine is newly built in the factory, the original vending software loaded on the Vending Machine Controller 100 in the factory can already provide support for the new MDB Slave peripheral from the start.

The Blu-ray disc in the Blu-ray player 106 contains a Java application that implements a graphical user interface, monitors incoming data on the network interface of the Blue-ray player 106, and uses a proprietary data communication protocol to communicate with the microcontroller 111 over the network connection. The data communication protocol can be used to: 1) signal button presses on the selection panel 101, 2) request item availability from the vending machine, 3) signal credit activity on the vending machine, 4) pass on the item selection to the vending machine, 5) request item pricing from the vending machine, 6) update item pricing on the vending machine, 7) request item stock from the vending machine, 8) request credit inventory from the vending machine, 9) request malfunction alerts from the vending machine, 10) increase the current credit value in the vending machine, etc. The Blu-ray disc can also contain video clips.

The Java application can send data to the microcontroller 111 over the network connection. The microcontroller 111 can send data to the Java application over the network connection. The Java application can receive data from the microcontroller 111 over the network connection. The microcontroller 111 can receive data from the Java application over the network connection.

Navigation in the graphical user interface to select an item on the vending machine: The user can use the selection panel 101 on the vending machine to navigate and make an item selection in a graphical user interface which is implemented as a Selections Blu-ray Menu: The microcontroller 111 translates a button press on the selection panel 101, to a network data segment that contains the “key event—navigation code”, which is sent over the network connection to the Java application. The Java application monitors the incoming data on the network interface of the Blue-ray player 106 and when it receives a “key event” it performs the corresponding navigation action for the “navigation code” within the graphical user interface.

Monitor credit activity on the vending machine: The microcontroller 111 is acting as an MDB Slave peripheral towards the vending machine, and monitors the incoming MDB data from the Vending Machine Controller 100, to monitor events from the vending machine and discover coin or bill insertions on the vending machine: When there is a coin insertion in the payment system, the Vending Machine Controller 100 signals this to the MDB Slave peripheral. The microcontroller 111 switches from IDLE mode to EVENT mode, and translates the coin insertion in the payment system, to a network data segment that contains the “credit event—coin type”, which is sent over the network connection to the Java application. The microcontroller 111 switches back to IDLE mode afterwards. The Java application monitors the incoming data on the network interface of the Blue-ray player 106 and when it receives a “credit event” it increases the internal credit status stored in a memory location with the corresponding “coin type” value, and updates the current credit status within the graphical user interface.

Request item availability for an item in the vending machine: The Java application can request information about item availability by sending a network data segment that contains the “item availability request—selected item”, over the network connection to the microcontroller 111: The microcontroller 111 monitors the incoming data on the network module 115 and when it receives an “item availability request” it switches from IDLE mode to REQUEST mode. The Vending Machine Controller 100 polls the MDB Slave peripheral for activity, and will see that the MDB Slave peripheral is asking for an “item availability” vending request. The Vending Machine Controller 100 checks the item availability for the specified item, and will send the requested vending information back to the MDB Slave peripheral over the MDB bus. The microcontroller 111 receives information about the item availability, and sends a network data segment with the “item availability status—selected item” over the network connection to the Java application. The microcontroller 111 switches back to IDLE mode afterwards. The Java application monitors the incoming data on the network interface of the Blue-ray player 106 and when it receives an “item availability status” it stores the item availability status for the “selected item” in a memory location. The Java application can check the item availability, for all available item selections up front, and can disable the items which are not available anymore in the Selections Blu-ray Menu.

Pass on an item selection to the vending machine: The Java application can pass on an item selection to the Vending Machine Controller 100 by sending a network data segment that contains the “item selection request—selected item”, over the network connection to the microcontroller 111: The microcontroller 111 monitors the incoming data on the network module 115 and when it receives an “item selection request” it switches from IDLE mode to REQUEST mode. The Vending Machine Controller 100 polls the MDB Slave peripheral for activity, and will see that the MDB Slave peripheral is asking for an “item selection” vending request. The Vending Machine Controller 100 will dispense the item if the item is available and enough credit was inserted, and will send a positive or negative acknowledgement back to the MDB Slave peripheral over the MDB bus. The microcontroller 111 receives the positive or negative acknowledgement, and sends a network data segment with the “item selection request—acknowledgement” over the network connection to the Java application. The microcontroller 111 switches back to IDLE mode afterwards. The Java application monitors the incoming data on the network interface of the Blue-ray player 106 and when it receives an “item selection request—acknowledgment” it can check if the acknowledgment was positive or negative, to see if the vend was successful or not.

People skilled in the art will recognize that the Java application on the Blu-ray player 106 in this embodiment can use similar methods and techniques to 1) request item pricing from the vending machine, 2) update item pricing on the vending machine, 3) request item stock from the vending machine, 4) request credit inventory from the vending machine, 5) request malfunction alerts from the vending machine, 6) increase current credit value in the vending machine, etc., through the MDB Slave peripheral.

In yet another embodiment of this invention (embodiment 4), a standard vending API is added to a traditional vending machine, to control and monitor the vending machine during normal operation, by integrating an extra microcontroller 111 in the vending machine which communicates with the vending machine over the vending peripheral bus, and acts as an MDB Slave peripheral which has its own unique peripheral address and proprietary vending command set, and in addition reads data from and writes data to the DEX connector in the vending machine. The standard vending API to control and monitor the vending machine during normal operation is implemented by means of a proprietary data communication protocol over a network connection between a consumer media playback device 106 and the extra microcontroller 111 in the vending machine. The consumer media playback device 106 runs an application that uses the standard vending API to control and monitor the vending machine during normal operation, and adds a graphical user interface, multimedia advertising and info kiosk capabilities to the vending machine.

In order to simplify the understanding of the invention, rather than describing the invention in abstract terms, some of the descriptions herein are in terms of a specific consumer media playback device with a network interface, namely a Blu-ray player 106. However, it should be understood that the invention is not limited for use by any specific consumer media playback device.

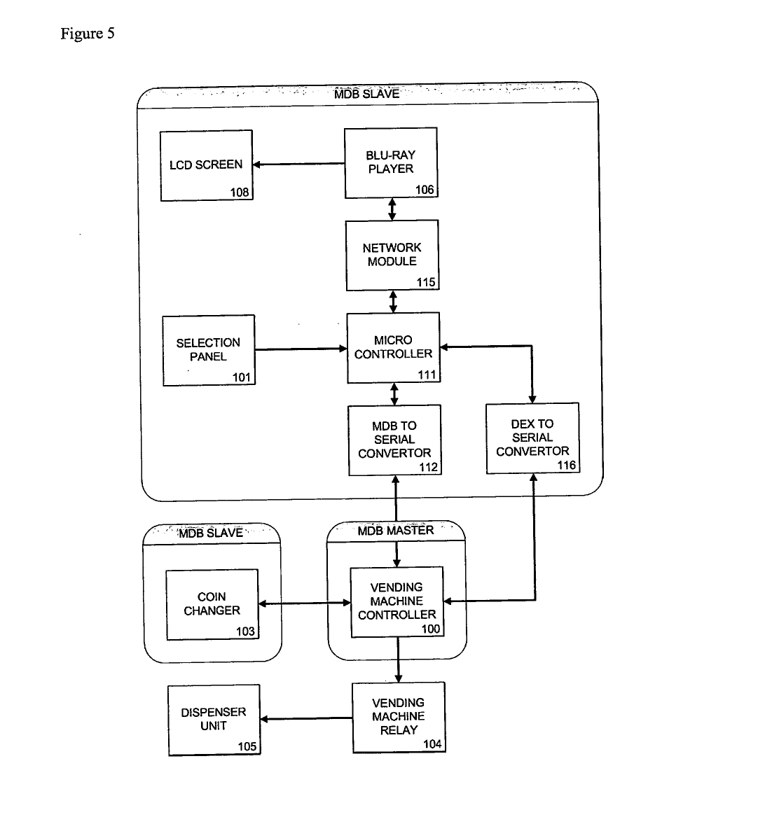

FIG. 5 shows an alternative Block diagram of an MDB Slave peripheral which adds a vending API to the vending machine, whereby the MDB Slave peripheral communicates with the DEX connector: In this embodiment, the microcontroller 111 communicates with the vending machine over the vending peripheral bus, and acts as an MDB Slave peripheral which has its own unique peripheral address and proprietary vending command set, and the microcontroller 111 in addition reads data from and writes data to the DEX connector in the vending machine.

The conversion circuit 116 is connected to the serial port on the microcontroller 111 and is used to convert the DEX protocol to standard serial data, so that the microcontroller 111 can write to and read from the DEX connector on the Vending Machine Controller 100. The expression “DEX connector on the Vending Machine Controller” can be used interchangeably with the expressions “DEX connector integrated in the Vending Machine Controller”, “integrated DEX connector in the Vending Machine Controller”, “DEX connector in the Vending Machine Controller”, “DEX connector connected to the Vending Machine Controller”.

People skilled in the art will recognize that the microcontroller 111 can read out vending audit data (snapshot of the cumulated stored information) from the Vending Machine Controller 100 through the DEX connector. People skilled in the art will recognize that the microcontroller 111 can write configuration data (test routines and machine setup) to the Vending Machine Controller 100 through the DEX connector.

The microcontroller 111 can request the item availability for the selected item through the DEX connector. The microcontroller 111 can request the item price for the selected item through the DEX connector. The microcontroller 111 can update the item price for the selected item through the DEX connector. People skilled in the art will recognize that the microcontroller 111 can request other vending audit data through the DEX connector, such as: item stock, total amount of cash, malfunction alerts, etc.

The Blu-ray disc in the Blu-ray player 106 contains a Java application that implements a graphical user interface, monitors incoming data on the network interface of the Blue-ray player 106, and uses a proprietary data communication protocol to communicate with the microcontroller 111 over the network connection. The data communication protocol can be used to: 1) signal button presses on the selection panel 101, 2) request item availability from the vending machine, 3) signal credit activity on the vending machine, 4) pass on the item selection to the vending machine, 5) request item pricing from the vending machine, 6) update item pricing on the vending machine, 7) request item stock from the vending machine, 8) request credit inventory from the vending machine, 9) request malfunction alerts from the vending machine, 10) perform a test routine on the vending machine, 11) update the software on the vending machine, 12) increase the current credit value in the vending machine, etc. The Blu-ray disc can also contain video clips.

The Java application can send data to the microcontroller 111 over the network connection. The microcontroller 111 can send data to the Java application over the network connection. The Java application can receive data from the microcontroller 111 over the network connection. The microcontroller 111 can receive data from the Java application over the network connection.

People skilled in the art will recognize that the microcontroller 111 in this embodiment can request vending information from the vending machine or perform an action on the vending machine through the MDB bus, or through the DEX connector, or through a combination of both.

People skilled in the art will recognize that it can be advantageous to have access to the DEX connector as well, as some vending request operations over the MDB bus could require too many changes in the original vending software on the Vending Machine Controller board 100, while the microcontroller 111 can read out vending audit data (snapshot of the cumulated stored information) from or write configuration data (test routines and machine setup) to the Vending Machine Controller 100 through the DEX connector.

People skilled, in the art will recognize that in this embodiment the vending machine will still signal events to the microcontroller 111 through the MDB bus, as the microcontroller 111 is acting as an MDB Slave peripheral towards the vending machine, and monitors the incoming MDB data from the Vending Machine Controller 100, to monitor events from the vending machine.

People skilled in the art will recognize that the methods and techniques in this embodiment are a combination of the methods and techniques in embodiment 2 and embodiment 3 of this invention.

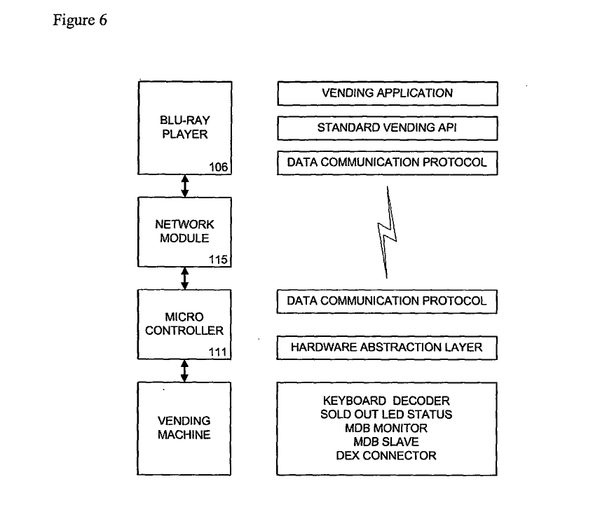

People skilled in the art will recognize that the standard vending API presented in several embodiments of the present invention makes abstraction of the underlying vending hardware and is identical for different vending machine brands and types. The microcontroller 111 implements a hardware abstraction layer to hide the underlying vending hardware towards the consumer media playback device 106. FIG. 6 shows the different abstraction layers in the presented embodiments.

The microcontroller integration in different embodiments of the present invention is based on different approaches to interface with the vending machine, such as: read from selection panel, write to keyboard decoder, read sold out leds, monitor MDB bus, act as MDB Slave on MDB bus, read from/write to DEX connector. People skilled in the art will recognize that the supported feature set of vending requests and vending events in the vending API depends on the level of the microcontroller integration in the vending machine: the available interfaces between the microcontroller 111 and the vending machine. E.g. the first embodiment in the present invention does not support the retrieval of vending audit data from the vending machine and the writing of configuration data to the vending machine. The standard vending API can implement a function to retrieve the available feature set, or can answer to an unsupported feature with the “Not Supported” answer.

People skilled in the art will recognize that additional interfaces can be added to the microcontroller 111, to extend the supported feature set of vending requests and vending events in the vending API described in the present invention. E.g. the microcontroller 111 can be connected to relays to control the main power, the lighting system, and/or the cooling system. The vending API can provide additional functions to implement intelligent energy management on a traditional vending machine. People skilled in the art will recognize that some Vending Machine Controllers 100 support the feature to control the lighting or the cooling system in the vending machine by sending a vend request to the DEX connector.

When this feature is supported by the Vending Machine Controller 100 in this embodiment, the microcontroller 111 does not need an extra interface and relays.

People skilled in the art will recognize that the events on the vending machine that are signaled from the microcontroller 111 to the consumer media playback device 106 can be handled on the consumer media playback device 106 through a callback function, which can be registered by the application on the consumer media playback device 106, and which will be triggered when a specific event takes place on the vending machine: e.g. item selected, coin inserted, etc.

People skilled in the art will recognize that the standard vending API software library can become an industry standard for writing new interactive vending portals for legacy vending machines: The standard vending API software library to control and monitor the vending machine during normal operation, provides 1) API functions to read vending information from the vending machine, 2) API functions to register callback functions that get triggered when an event takes place on the vending machine, 3) API functions to write configuration data or send actions to the vending machine. People skilled in the art will recognize that the functions provided by the standard vending API can be used for the implementation of a service application which can be used by the vending operator for servicing the vending machine during installation or maintenance of the vending machine.

In yet another embodiment of this invention (embodiment 5), a future Vending Machine Controller 100 can be equipped with a network connector and on-board software that implements the proprietary data communication protocol as described in several embodiments of the present invention. This would avoid the need for an extra microcontroller 111 in the vending machine, and allows a direct connection between the Vending Machine Controller 100 and the consumer media playback device 106.

In order to simplify the understanding of the invention, rather than describing the invention in abstract terms, some of the descriptions herein are in terms of a specific consumer media playback device with a network interface, namely a Blu-ray player 106. However, it should be understood that the invention is not limited for use by any specific consumer media playback device.

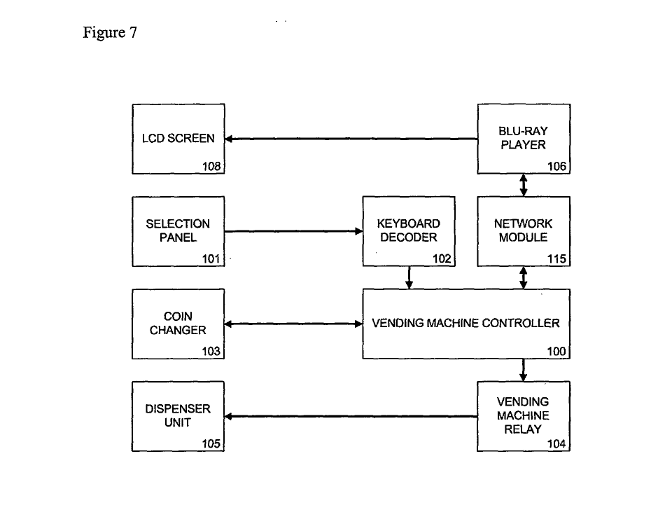

FIG. 7 shows the connection of such a future Vending Machine Controller 100. The network module 115 can be integrated in the Vending Machine Controller 100.

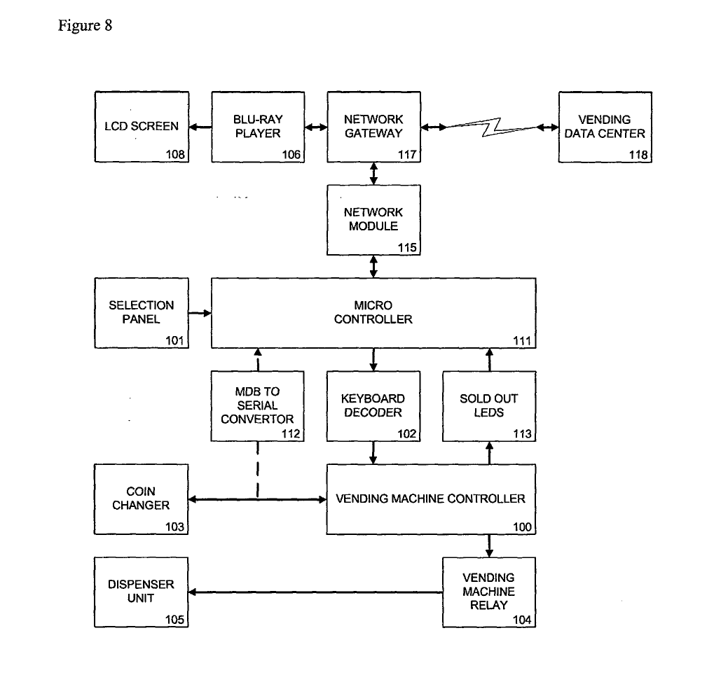

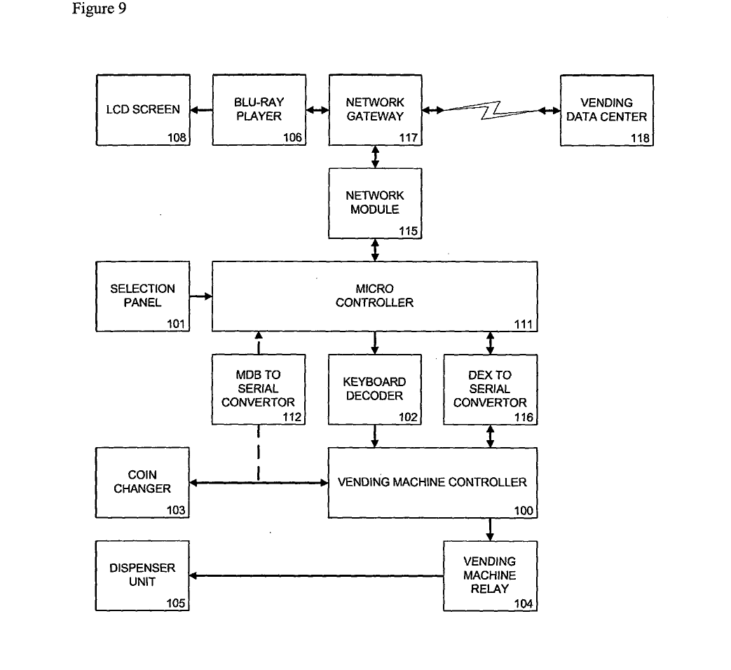

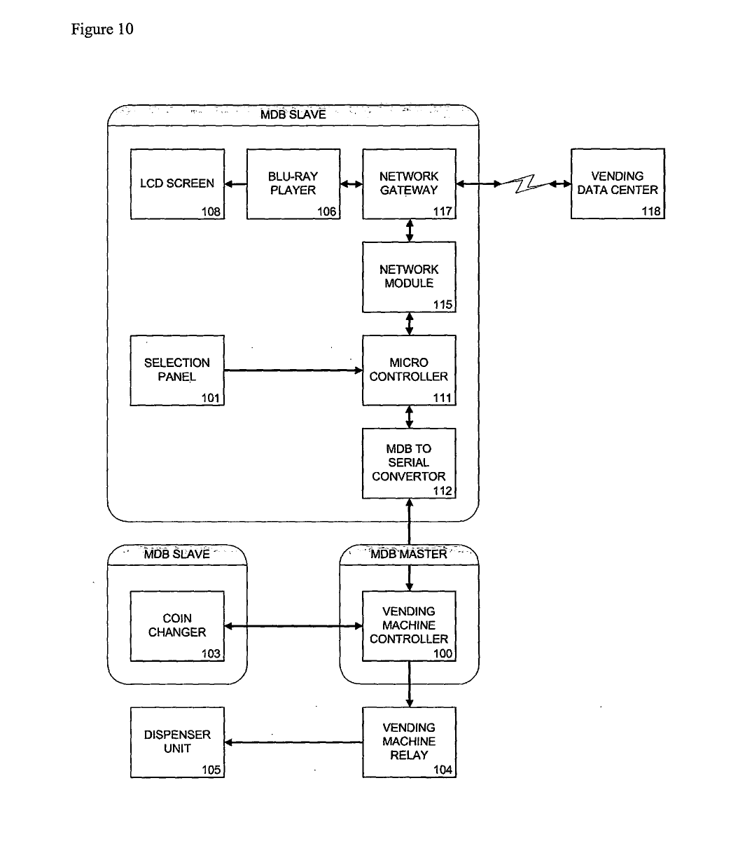

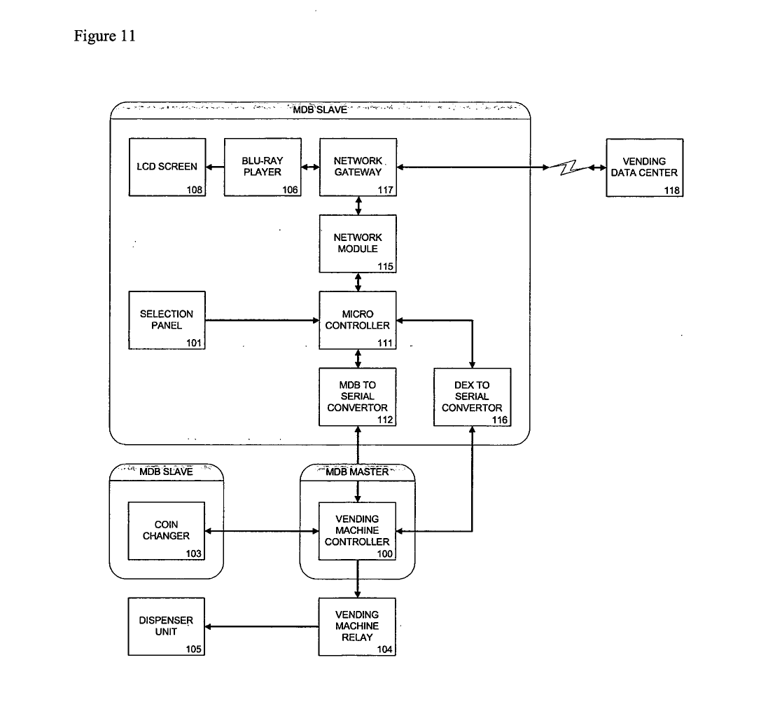

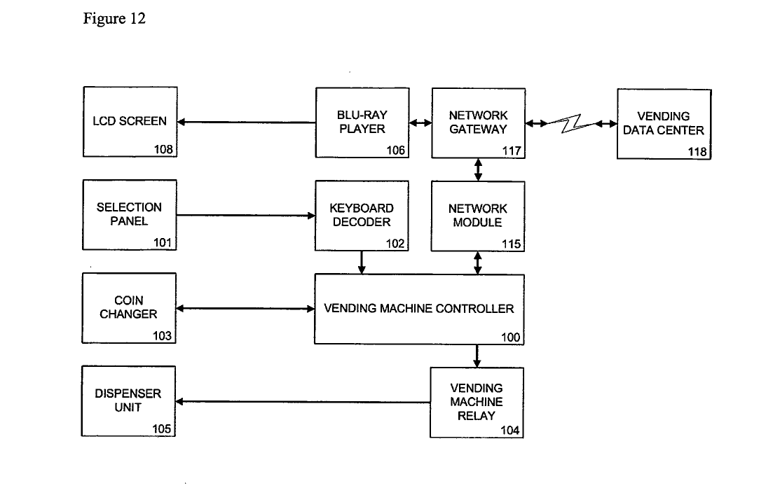

People skilled in the art will recognize that the network connection in the embodiments of the present invention can open up a communication link to an external vending data center 118, which can be used for a telemetry solution that provides remote monitoring and remote controlling. This can be achieved by placing a network gateway 117 in between the network module 115 on the microcontroller 111 and the network interface of the consumer media playback device 106. The vending data center 118 is connected to the network gateway 117, and communicates with the consumer media playback device 106 using a proprietary data communication protocol. FIGS. 8-12 show the alternative embodiments of the present invention in which the network gateway 117 has been added in between the network module 115 on the microcontroller 111 and the network interface of the consumer media playback device 106.

People skilled in the art will recognize that the Blu-ray disc in the Blu-ray player 106 can contain Java classes which implement the standard vending API and make abstraction of the underlying proprietary data communication protocol, and provide the following functionality to the Java application, including but not limited to:

1) API function to register a callback function which signals button presses on the selection panel 101, 2) API function to request item availability from the vending machine, 3) API function to register a callback function which signals credit activity on the vending machine, 4) API function to pass on the item selection to the vending machine, 5) API function to request item pricing from the vending machine, 6) API function to update item pricing on the vending machine, 7) API function to request item stock from the vending machine, 8) API function to request credit inventory from the vending machine, 9) API function to request information about malfunction alerts on the vending machine, 10) API function to perform a test routine on the vending machine, 11) API function to update the software on the vending machine, 12) API function to increase the current credit value in the vending machine, etc.

People skilled in the art will recognize that the API function to increase the current credit value in the vending machine can be used to add additional payment means to the vending machine.

People skilled in the art will recognize that the vending machine manufacturers, vending operators and/or advertisement agencies can use off the shelf Blu-ray authoring packages to author a Blu-ray disc which contains video clips, and an application that uses the standard vending API to control and monitor the vending machine during normal operation and adds a graphical user interface, multimedia advertising and info kiosk capabilities to the vending machine.

People skilled in the art will recognize that the vending machine manufactures can use off the shelf Blu-ray authoring packages to author a service Blu-ray disc which contains an application that uses the standard vending API to perform servicing on the vending machine during installation or maintenance of the vending machine.

People skilled in the art will appreciate that proper tools and templates can be provided to simplify the authoring/mastering process of Blu-ray discs that comply with the specifications of the solution described in this invention.

People skilled in the art will recognize that the microcontroller 111 can alternatively send a button press on the selection panel 101, through an IR sender module connected to the microcontroller 111, which sends an infrared signal to the infrared input of the Blu-ray player 106, instead of sending a network data segment that contains the “key event—navigation code” over the network connection to the Java application. People skilled in the art will recognize that a direct physical connection can be realized between the microcontroller 111 and the electronics after the IR receiver on the Blu-ray player 106.

People skilled in the art will recognize that in the nearby future it is feasible that touch screen LCD/Blu-ray combos will be released on the market. In this case such a combination of touch screen LCD 108 and Blu-ray player 106 could be used in our proposed vending solution. There will be no need for a selection panel 101 anymore, since any user interaction is performed by selecting menu items on the touch screen 108.

People skilled in the art will recognize that future Blu-ray and Blu-ray-like platforms could support different types of media including but not limited to hard disks, flash memory, memory sticks, USB sticks or any other high capacity medium suitable to store digital encoded video assets and the application that accesses the standard vending API to control and monitor the vending machine.

Those skilled in the art will understand that although a Blu-ray player 106 is used in several embodiments of the present invention, this is not to be limiting. A Blu-ray player 106 is used as a convenient consumer media playback device 106 which has a network interface. However, other consumer media playback devices 106 with a network interface could equally well function. The present invention could be implemented using a Smart phone, a Tablet, or other equivalent consumer media playback devices 106 which have a network interface or the like.

People skilled in the art will recognize that the embodiments of the present invention can be provided as a retro-fit kit to upgrade existing vending machines, or can be installed in a new vending machine during production in the factory.

It should be apparent to one skilled in the art that the present invention may be practiced without the specific details described in the embodiments. In some instances, well known circuits and devices are shown in block diagram form in order not to obscure the present invention unnecessarily. It is appreciated that the steps in the described methods may be performed in an order different than presented, and that not all the steps may be performed.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

1-17. (canceled)

18. An apparatus to control and/or monitor a vending machine, said apparatus comprising:
a playback device;
a display device coupled to said playback device;
an interface between said playback device and said vending machine; and
a software API library;
wherein said playback device is a device that can play back digital encoded video assets, and is operated by a graphical user interface that supports at least a level of user interactivity and navigation features to navigate within menus and play back a video clip,
wherein said graphical user interface of said playback device provides user interactivity and navigation features to select items in said vending machine,
wherein said interface provides a hardware abstraction layer to said vending machine, which hides the underlying hardware in said vending machine from said playback device,
wherein said software API library is implemented on top of said hardware abstraction layer and can be used to control and/or monitor said vending machine from a software application running on said playback device,
wherein said playback device runs a software application that uses said software API library to control and/or monitor said vending machine from said software application.

19. The apparatus according to claim 18, wherein said apparatus is integrated into said vending machine.

20. The apparatus according to claim 18, wherein said interface further comprises one or more of:
an interface with a selection panel in said vending machine;
an interface with a keyboard decoder in said vending machine;
an interface with the sold out light emitting diodes (LEDs) in said vending machine;
an interface with a drop sensor in said vending machine;
an interface with a vending machine peripheral bus in said vending machine;
an interface with a DEX connector in said vending machine;
an interface with a network connection in said vending machine;

21. The apparatus according to claim 18, wherein said software API library is implemented by a protocol between said playback device and said vending machine over said interface.

22. The apparatus according to claim 18, wherein said software API library comprises one or more API functions to:
dispense an item selected in said graphical user interface;
check or monitor an item availability in said vending machine;
check a credit status or monitor credit activity in said vending machine;
monitor button presses on a selection panel in said vending machine;
request an item pricing in said vending machine;
update an item pricing in said vending machine;
request or monitor an item stock in said vending machine;
request or monitor a credit inventory in said vending machine;
request or monitor information about malfunction alerts in said vending machine;
increase or change the credit value in said vending machine;
request information from said vending machine;
monitor events in said vending machine;
request an action from said vending machine;
read audit data from said vending machine;
write configuration data to said vending machine;
perform a test routine on said vending machine;
update software in said vending machine;

23. The apparatus according to claim 18, wherein said interface is configured such that said apparatus is to control and/or monitor said vending machine from said playback device without any hardware modification to said playback device.

24. The apparatus according to claim 18, wherein said interface is configured such that said apparatus is to control and/or monitor said vending machine from said playback device without having to replace or modify a vending machine controller in said vending machine, and whereby said vending machine controller in said vending machine is responsible for control of and activities in said vending machine.

25. The apparatus according to claim 18, wherein said interface is configured such that said apparatus is to control and/or monitor said vending machine from said playback device without having to modify a software program running on a vending machine controller in said vending machine.

26. The apparatus according to claim 18, wherein said playback device is operated by a touch screen integrated into said display device, and whereby said user interactivity with said vending machine is performed by selecting items on said touch screen.

27. The apparatus according to claim 18, wherein said playback device is a DVD player, a DVD-like player, a Blu-ray player, a smart phone, or a tablet device.

28. The apparatus according to claim 18, wherein said apparatus is a vending machine peripheral device and communicates with a vending machine controller in said vending machine through a standard vending machine peripheral bus in said vending machine.

29. The apparatus according to claim 18, wherein said interface further comprises:
a microcontroller;
an interface between said playback device and said microcontroller; and
an interface between said microcontroller and said vending machine, wherein said microcontroller implements said protocol between said playback device and said vending machine.

30. The apparatus according to claim 18, wherein said interface further comprises a communication link that provides remote monitoring and/or controlling to said vending machine for a telemetry solution.

31. A method to control and/or monitor a vending machine, said method comprising the steps of:
1) integrating said apparatus of claim 18 in said vending machine;
2) providing an interface between said playback device and said vending machine; and
3) running a software application on said playback device that uses said software API library to control and/or monitor said vending machine from said software application;

32. The method according to claim 31, wherein said steps further comprise: modifying a program instruction code on a vending machine controller in said vending machine to integrate said apparatus in operation of said vending machine.

33. A hardware abstraction layer for a vending machine, which hides the underlying hardware in said vending machine from a playback device,
wherein said playback device is a device that can play back digital encoded video assets, and is operated by a graphical user interface that supports at least a level of user interactivity and navigation features to navigate within menus and play back a video clip,
and wherein said hardware abstraction layer is implemented by an interface between said playback device and said vending machine.

34. The hardware abstraction layer according to claim 33, wherein said interface further comprises one or more of:
an interface with a selection panel in said vending machine;
an interface with a keyboard decoder in said vending machine;
an interface with the sold out light emitting diodes (LEDs) in said vending machine;
an interface with a drop sensor in said vending machine;
an interface with a vending machine peripheral bus in said vending machine;
an interface with a DEX connector in said vending machine;
an interface with a network connection in said vending machine;

35. The hardware abstraction layer according to claim 33, wherein said interface further comprises:
a microcontroller;
an interface between said playback device and said microcontroller; and
an interface between said microcontroller and said vending machine, wherein said microcontroller implements said protocol between said playback device and said vending machine.

36. A software API library for a vending machine, to control and/or monitor said vending machine from a software application,
wherein said software API library hides the underlying hardware in said vending machine from said software application,
and wherein said software API library can be used to develop software applications for vending machines that will run on different vending machine brands or types.

37. The software API library according to claim 36, wherein said software API library comprises one or more API functions to:
dispense an item selected in said graphical user interface;
check or monitor an item availability in said vending machine;
check a credit status or monitor credit activity in said vending machine;
monitor button presses on a selection panel in said vending machine;
request an item pricing in said vending machine;
update an item pricing in said vending machine;
request or monitor an item stock in said vending machine;
request or monitor a credit inventory in said vending machine;
request or monitor information about malfunction alerts in said vending machine;
increase or change the credit value in said vending machine;
request information from said vending machine;
monitor events in said vending machine;
request an action from said vending machine;
read audit data from said vending machine;
write configuration data to said vending machine;
perform a test routine on said vending machine;
update software in said vending machine;

38. A vending machine wherein a graphical user interface for operating said vending machine is implemented by integrating an apparatus according to claim 18.
